(19) United States
(12) Patent Application Publication
(10) Pub. No.: US 2005/0067545 A1
(43) Pub. Date: Mar. 31, 2005

(54) Ceiling fixture support with shallow housing

(76) Inventors: Todd A. Coble, Stanfield, NC (US); Steven K. Peetz, Mooresville, NC (US); John F. Myers, Liverpool, NY (US)

Correspondence Address: BOND, SCHOENECK & KING, PLLC, 10 BROWN ROAD, SUITE 201, ITHACA, NY, 14850-1248, US

(21) Appl. No.: 10/672,421

(22) Filed: Sep. 26, 2003

(51) Int. Cl. B42F 13/00

(52) U.S. Cl. 248/343

(57) ABSTRACT

The present invention is directed to a ceiling fixture support assembly for mounting an electrical fixture to at least one structural support member. The assembly includes an electrical box that has a base member and a side member. The base member is substantially disk shaped, having a first beveled edge and a second beveled edge disposed parallel to the first beveled edge. The side member is connected to the base member to form an interior volume. The side member has a first flat portion corresponding to the first beveled edge, and a second flat portion corresponding to the second beveled edge. A fixture support assembly includes a first fixture support configured to be coupled to the first flat portion, and a second fixture support configured to be coupled to the second flat portion. The fixture support assembly is configured to support a ceiling fixture within the interior volume. A mounting assembly is configured to couple the electrical box to the structural support member.

### BACKGROUND OF THE INVENTION

1. Field of the Invention

The present invention relates generally to electrical device mounting assemblies, and particularly to a stable, shallow mounting assembly for ceiling fans and light fixtures.

2. Technical Background

Ceiling fixture support structures must meet ever-increasing demands for strength and stability. Ceiling mounting assemblies are typically designed to accommodate a light fixture, a ceiling fan, or a combination thereof. Further, large ceiling fans and chandeliers are becoming increasingly common. These fixtures must be securely anchored to a ceiling joist, or some other structural member, to support the static load and/or the dynamic load. Every fixture has its own unique set of mounting problems. However, ceiling fans typically include large heavy motors and integrated lighting fixtures that are characterized by large static loads when mounted on a ceiling. The rotation of the fan blades also provides a dynamic load that must be considered when designing the fixture support structure.

At the same time, the fixture support assembly must not occupy a significant portion of the interior volume of a ceiling box. What is needed is a shallow housing that includes a compact fixture support structure that can withstand the aforementioned static and dynamic loads.

### SUMMARY OF THE INVENTION

The present invention addresses the needs described above. The present invention provides a fixture support assembly that does not occupy a significant portion of the interior volume of a shallow ceiling box. On the other hand, the compact fixture support assembly is well able to accommodate the static and dynamic loads characteristic of modem ceiling fixtures.

One aspect of the present invention is directed to a ceiling fixture support assembly for mounting an electrical fixture to at least one structural support member. The assembly includes an electrical box that has a base member and a side member. The base member is substantially disk shaped, having a first beveled edge and a second beveled edge disposed parallel to the first beveled edge. The side member is connected to the base member to form an interior volume. The side member has a first flat portion corresponding to the first beveled edge, and a second flat portion corresponding to the second beveled edge. A fixture support assembly includes a first fixture support configured to be coupled to the first flat portion, and a second fixture support configured to be coupled to the second flat portion. The fixture support assembly is configured to support a ceiling fixture within the interior volume. A mounting assembly is configured to couple the electrical box to the structural support member.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a plan view of the ceiling box in accordance with the present invention;

FIG. 2 is a perspective view of a U-bracket in accordance with the present invention;

FIG. 3 is a detail view of a fixture support mount in accordance with the present invention;

FIG. 4 is a top exploded view of the ceiling fixture support assembly in accordance with the present invention;

FIG. 5 is a bottom exploded view of the ceiling fixture support assembly in accordance with the present invention;

FIG. 6 is a top perspective view of the assembled ceiling fixture support assembly in accordance with the present invention;

FIG. 7 is a bottom perspective view of the assembled ceiling fixture support assembly in accordance with the present invention;

FIG. 8 is a detail view of a mounted assembled ceiling fixture support assembly in accordance with the present invention; and

FIG. 9 is an alternate detail view of a mounted assembled ceiling fixture support assembly in accordance with the present invention.

### DETAILED DESCRIPTION

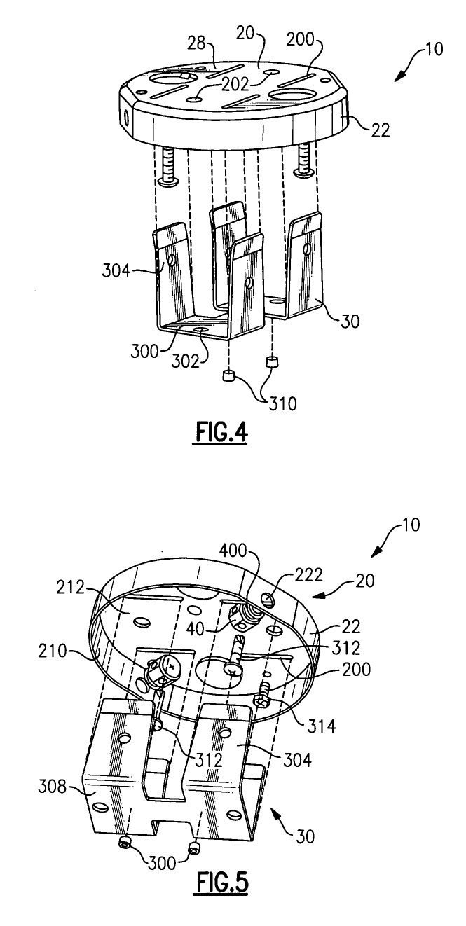

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the ceiling fixture support assembly of the present invention is shown in FIG. 4, and is designated generally throughout by reference numeral 10.

In accordance with the invention, the present invention provides a ceiling fixture support assembly 10 for mounting an electrical fixture to at least one structural support member. The assembly includes an electrical box 20 that has a base member and a side member. The base member is substantially disk shaped, having a first beveled edge and a second beveled edge disposed parallel to the first beveled edge. The side member is connected to the base member to form an interior volume. The side member has a first flat portion corresponding to the first beveled edge, and a second flat portion corresponding to the second beveled edge. A fixture support assembly 40 includes a first fixture support configured to be coupled to the first flat portion, and a second fixture support configured to be coupled to the second flat portion. The fixture support assembly is configured to support a ceiling fixture within the interior volume. A mounting assembly 30 is configured to couple the electrical box 20 to the structural support member.

As a result, the present invention provides a fixture support assembly that does not occupy a significant portion of the interior volume of a shallow ceiling box. On the other hand, the compact fixture support assembly is well able to accommodate the static and dynamic loads characteristic of modem ceiling fixtures.

As embodied herein, and depicted in FIG. 1, a plan view of electrical box 20 in accordance with the present invention is disclosed. Electrical box 20 includes a flat disk shaped member 24 and side member 22 that together form an interior volume 26. Disk plate member 24 includes slots 200 and connector openings 202 which are configured to accommodate the mounting assembly 30 coupling mounting assembly 30 to electrical box 20. Openings 204 are configured to accommodate screws for a direct mounting of box 20 to a structural member. Disk shaped member 24 also includes parallel beveled edges 240. Side member 22 includes flat portions 220 that correspond to the beveled edges 240. A fixture mount opening 222 is provided in each flat portion 220. Flat portions 220 are an important feature because they provide a more stable connecting surface for fixture mounts 40 (not shown in FIG. 1).

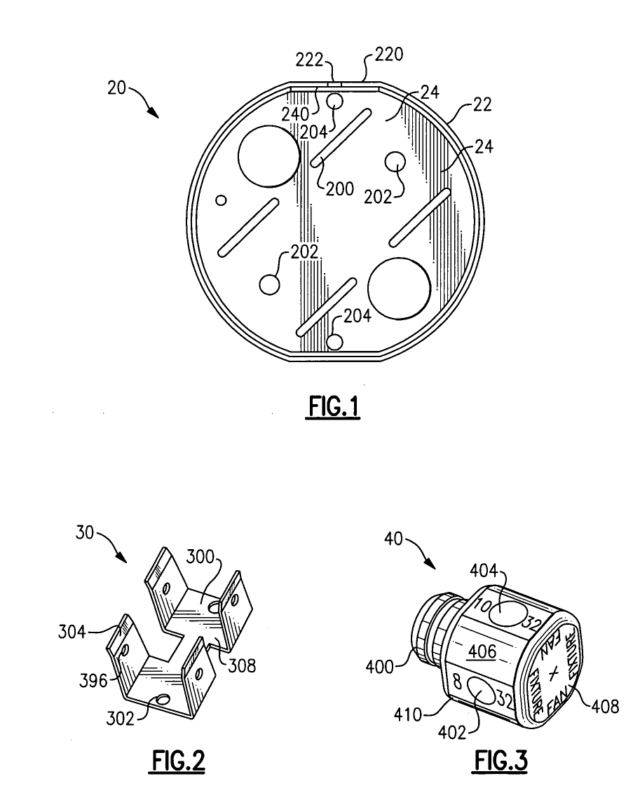

As embodied herein, and depicted in FIG. 2, a perspective view of mounting assembly 30 in accordance with a first embodiment of the present invention is disclosed. Mounting assembly 30 includes U-bracket 300 and snap-in rivets 310 (FIG. 4). U-bracket 300 includes a base member 308 and a plurality of tab members 304. In the embodiment shown in FIG. 2, there are four tab members 304, but those of ordinary skill in the art will understand that U-bracket 300 may be configured with 2N tabs, where N is an integer value. Each tab member 304 includes opening 306 which accommodates a connector for coupling bracket 300 to a structural member. Base member 308 is secured to electrical box 20 with the press-in rivets.

As embodied herein, and depicted in FIG. 3 a detail view of fixture support mount 40 in accordance with the present invention is disclosed. Each mount 40 includes a specially designed shaft portion 400 and support portion 410. Support, portion 410 includes threaded hole 404 and threaded hole 402. Threaded hole 402 is a size 8 (8/32 inches) hole, used to support a light fixture. Threaded hole 404 is a size 10 hole, used to support a ceiling fan, or a ceiling fan/light fixture combination. Fixture support 40 includes rounded portion 406 which allow support 40 to rotate freely without hitting the bottom plate member 24 of the box 20. Face portion 408 is labeled appropriately to show the installer if mount is positioned to support a fan or a light fixture.

Referring to FIG. 4, a top exploded view of the ceiling fixture support assembly 10 in accordance with the present invention is disclosed. As shown, tab members 304 are inserted into slots 200. Hole openings 302 in U-bracket 300 match hole openings 202 in box 20. These holes may be used to mount specific fan designs that require the fan screws to be anchored directly to the joist. Press-in rivets 310 are inserted through U-bracket 300 and electrical box 20 to secure them together. The rivets are of a type that requires no lead hole. During installation, face portion 28 is disposed flush against the structural member, or may be dropped down for adjustment in firewall applications where two layers of wallboard are used

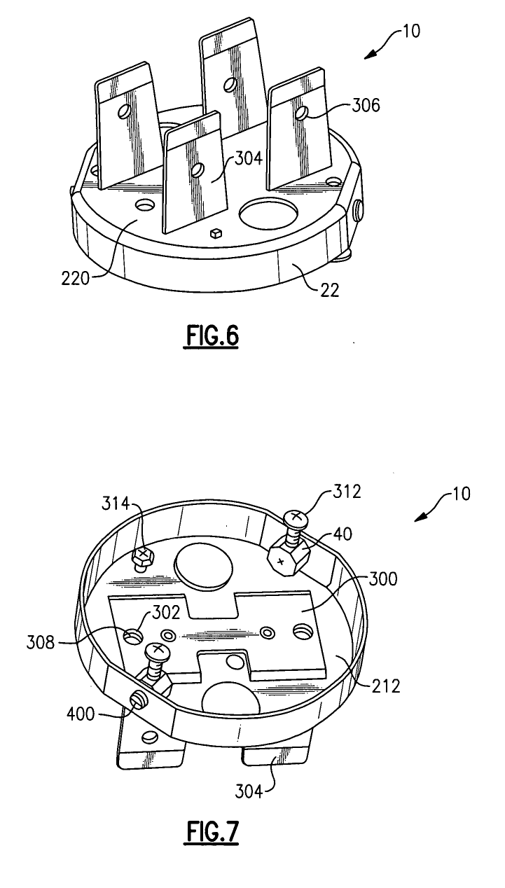

Referring to FIG. 5, a bottom exploded view of the ceiling fixture support assembly 10 in accordance with the present invention is shown. In this view, it is seen that base member 308 of bracket 300 is disposed flush against interior face portion 212 of box 20 when box 20 is installed. Two support mounts 40 are typically employed in electrical box 20. Specially designed shaft, portion 400 is inserted into opening 222 from the interior portion 26 of electrical box 20, and shaft 400 is orbitally riveted to secure mount 40 to electrical box 20. Orbital riveting deforms shaft 400 to prevent the removal of mount 40 from electrical box 20 after installation. Once mounted, screws 312 are used to secure a fan or light fixture to support mounts 40. If bracket 30 is not used, electrical box 20 may be directly secured to the structural member by any suitable fastener. FIG. 6 is a top perspective view of the assembled ceiling fixture support assembly 10. Assembly 10 is mounted to a structural member, such as a joist, by inserting the joist between tab members 304. The assembly 10 is secured thereto by inserting screws through holes 306 and fastening them to the joist. FIG. 7 is a bottom perspective view of the assembled ceiling fixture support assembly 10.

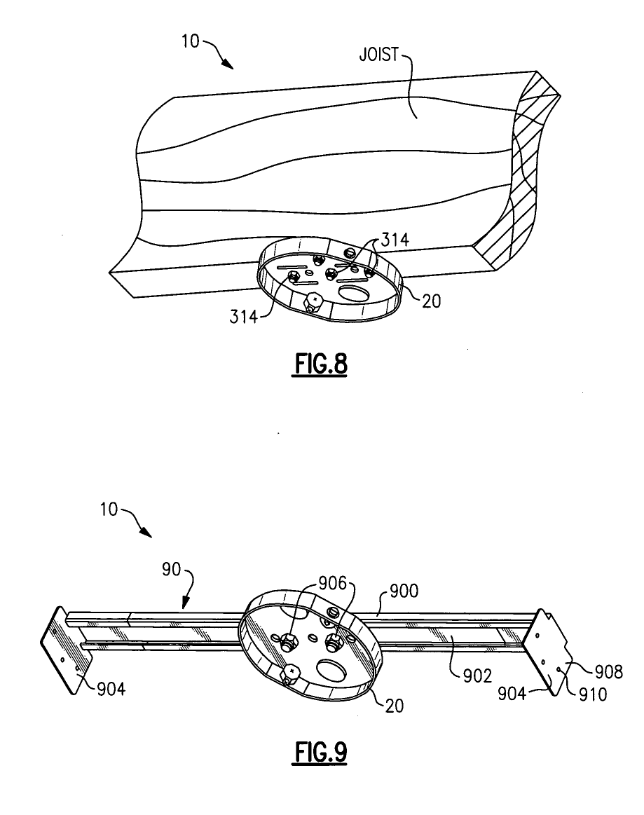

Referring to FIG. 8, a detail view of a mounted assembled ceiling fixture support assembly 10 in accordance with a second embodiment of the present invention is disclosed. As alluded to above, electrical box 20 may be mounted directly to the joist by fasteners (not shown).

As embodied herein, and depicted in FIG. 9, a detail view of a mounted assembled ceiling fixture support assembly 10 in accordance with a third embodiment of the present invention is disclosed. In this embodiment, mounting assembly 90 includes a slide rail 900 and a slide member 902 disposed within the slide rail 900. The slide rail is configured to be connected to structural members at either end. The slide member 902 is configured to move along a linear direction within the slide mount rail until positioned as desired. The slide member 902 is also configured to be coupled to the electrical box 20 via connectors 906. 17. Slide rail 900 includes connectors 904 disposed on either end of rail 900. Each connector 904 includes a plate member 908 have screw hole openings 910 for mounting rail 900 to the structural member.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A ceiling fixture support assembly for mounting an electrical fixture to at least one structural support member, the assembly comprising:
an electrical box including a base member and a side member, the base member being substantially disk shaped having a first beveled edge and a second beveled edge disposed parallel to the first beveled edge, the side member being connected to the base member to form an interior volume, the side member having a first flat portion corresponding to the first beveled edge and a second flat portion corresponding to the second beveled edge;
a fixture support assembly including a first fixture support configured to be coupled to the first flat portion and a second fixture support configured to be coupled to the second flat portion, the fixture support assembly being configured to support a ceiling fixture within the interior volume; and
a mounting assembly configured to couple the electrical box to the structural support member.

2. The assembly of claim 1, wherein the electrical box is configured to be coverable by a fixture base cover.

3. The assembly of claim 1, wherein the fixture support assembly is configured to support a ceiling fan fixture.

4. The assembly of claim 3, wherein the ceiling fan fixture includes a light fixture.

5. The assembly of claim 1, wherein the fixture support assembly is configured to support a lighting fixture.

6. The assembly of claim 1, wherein the base member includes a plurality of slots configured to accommodate the mounting assembly.

7. The assembly of claim 6, wherein the mounting assembly includes a U-shaped bracket having a plurality of tab members, each tab member corresponding to one of the plurality of slots.

8. The assembly of claim 6, wherein the mounting assembly further comprises:
a flat support member configured to be connected to a first side of the base member when the bracket assembly is coupled to the electrical box; and
a plurality of tab members connected to the flat support member, each tab member being configured to be inserted into a corresponding one of the plurality of slots, whereby each tab member is disposed on a second side of the base member when the bracket assembly is coupled to the electrical box.

9. The assembly of claim 8, wherein the flat support member is substantially rectangular in shape.

10. The assembly of claim 8, wherein the flat support member is an H-shaped member.

11. The assembly of claim 8, wherein each of the plurality of tab members is configured to be mounted to the at least one structural support member.

12. The assembly of claim 11, wherein the at least one structural support member includes a joist member.

13. The assembly of claim 8, wherein the plurality of tab members includes four tab members.

14. The assembly of claim 8, wherein the flat support member is configured to be connected to a first side of the base member by a plurality of connectors.

15. The assembly of claim 13, wherein the plurality of connectors include press-in rivets.

16. The assembly of claim 1, wherein the mounting assembly further comprises:
a slide mount rail configured to be connected to the at least one structural member; and
a slide member disposed within the slide mount rail and configured to move along a linear direction within the slide mount rail, the slide member being configured to be coupled to the electrical box.

17. The assembly of claim 16, wherein the slide mount rail includes a first connector disposed at a first end of the slide mount rail, and a second connector disposed at a second end of the slide mount rail distal to the first end.

18. The assembly of claim 17, wherein the first connector includes a first plate member configured to be mounted to a first structural member, and the second connector includes a second plate member configured to be mounted to a second structural member.

19. The assembly of claim 1, wherein the first fixture support includes a specially designed shaft configured to be inserted and orbitally riveted into an opening in the first flat portion, and the second fixture support includes a specially designed shaft configured to be inserted and orbitally riveted into an opening in the second flat portion.

20. The assembly of claim 1, wherein the first fixture support and the second fixture support each include connector holes configured to accommodate connectors for mounting the fixture.

21. The assembly of claim 1, wherein the mounting assembly comprises a plurality of connectors.
